(19) United States
(12) Patent Application Publication
(10) Pub. No.: US 2025/0255422 A1
(43) Pub. Date: Aug. 14, 2025

(54) GLASS BOTTOM CERAMIC VESSEL

(71) Applicant: Catherine Herriman, Hudson, WI (US)

(72) Inventor: Catherine Herriman, Hudson, WI (US)

(21) Appl. No.: 19/030,373

(22) Filed: Jan. 17, 2025

Related U.S. Application Data
(60) Provisional application No. 63/551,891, filed on Feb. 9, 2024.

(51) Int. Cl. A47G 19/22; C04B 37/04

(52) U.S. Cl. CPC A47G 19/2205; C04B 37/045; C04B 2237/32; C04B 2237/80; C04B 2237/82

(57) ABSTRACT

A vessel comprises a ceramic body and a glass bottom. The glass bottom is formed of a first glass portion and a second glass portion which are fused together.

### CROSS-REFERENCE TO RELATED APPLICATION

This application claims priority to U.S. Provisional Application No. 63/551,891, filed Feb. 9, 2024, which is herein incorporated by reference in its entirety.

### FIELD OF THE INVENTION

The field of the subject matter is a ceramic object or vessel, such as a mug, plate or vase, having a glass bottom.

### DESCRIPTION OF RELATED ART

The field of the subject matter is a ceramic object or vessel, such as a mug, plate or vase, having a glass bottom. Tableware or dishware such as plates, bowls, mugs, cups and saucers are vessels designed to hold food or liquid without leaking. They can be formed from a variety of materials including ceramic, or clay hardened by heat (i.e. fire). Tableware must be functional. It should be able to hold food or liquid without leaking and be food safe. In some situations, it may also be desirable that such vessels are visually appealing.

Other vessels, such as vases and coasters may also be formed from ceramic. It may also be desirable that these items and others, such as suncatchers, be functional while also be visually appealing.

It is desirable to incorporate glass into ceramic vessels. However, the expansion rates and melting points of glass and ceramic typically differ, making them generally incompatible. Further, one way to combine ceramics and glass is in the cold state with the use of adhesives. However, these adhesives are seldom durable and food safe. A new method of incorporating glass into ceramic is needed.

### SUMMARY OF THE INVENTION

These and other needs are addressed by the various aspects, embodiments, and configurations of the present disclosure.

In Example 1, a vessel includes a ceramic body having a top edge, a bottom edge, a wall extending from the top edge to the bottom edge to form an enclosed space and a floor extending inward from an inside surface of the wall, the floor having an inner surface, an outer surface and a vertical surface that defined an opening in the ceramic body; and a glass bottom covering the opening, the glass bottom formed of a first portion and a second portion which are fused together, wherein the first portion has a first top surface and a first bottom surface and the second portion has a second top surface and a second bottom surface; the first bottom surface of the first portion is in contact with at least a portion of the inner surface of the floor and at least a portion of the second top surface of the second portion; the second top surface of the second portion is in contact with at least a portion of the first bottom surface of the first portion and at least a portion of the outer surface of the floor.

In Example 2, the vessel of Example 1 wherein at least a portion of the inner surface of the floor which is in contact with the first glass portion and at least a portion of the outer surface of the floor which is in contact with the second glass portion include at least one glaze.

In Example 3, the vessel of Example 1 wherein the vessel is watertight.

In Example 4, The vessel of Example 1 wherein the ceramic body is cylindrical.

In Example 5, the vessel of vessel of Example 4 wherein the opening is circular.

In Example 6, the vessel of Example 5 wherein the floor includes one or more supports and the first portion and the second portion are in contact with the one or more supports.

In Example 7, the vessel of Example 6 wherein a diameter of the first portion is larger than a diameter of the opening, and wherein the diameter of the second portion is larger than the diameter of the first portion.

In Example 8, the vessel of Example 6 wherein the support forms a notch.

In Example 9, the vessel of Example 6 wherein the vessel includes two or more supports extend radially inward from the floor towards the opening and wherein the supports do not extend an entire perimeter of the opening.

In Example 10, the vessel of Example 1 wherein the bottom surface of the second portion is laterally upwards from the bottom edge.

In Example 11, the vessel of Example 1 wherein the inner surface of the floor and the top surface of the first portion form a flat or substantially flat surface.

In Example 12, the vessel of Example 1 wherein the vessel is a drinking vessel.

In Example 13, the vessel of Example 1 wherein the vessel is a mug.

In Example 14, the vessel of Example 1 wherein the glass bottom further comprises a third glass portion positioned between the first glass portion and the second glass portion, the first glass portion, second glass portion and third glass portion fused together.

In Example 15, the vessel of Example 1 and further comprising a sealant contacting the ceramic body and the glass bottom.

In Example 16, a method of forming a glass bottom vessel includes positioning a first glass portion in contact with at least a portion of an inner surface of a floor extending inward from an inside surface of a wall of a ceramic body and over an opening formed in a bottom of the ceramic body; positioning a second glass portion in contact with at least a portion of an outer surface of the floor; and fusing the first glass portion to the second glass portion to sandwich the floor between the first glass portion and the second glass portion.

In Example 17, a method of Example 16 wherein the step of positioning the first glass portion includes position the first glass portion in a notch.

In Example 18, the method of Example 16 wherein the step of positioning the second glass portion includes elevating the second glass portion so that an outer surface of the second glass surface is laterally upwards from a bottom edge of the ceramic body.

In Example 19, the method of Example 16 wherein the ceramic body has been glaze fired before the step of positioning the first glass portion.

In Example 20, the method of Example 16 wherein the outer surface and the inner surface have a glaze.

In Example 21, the method of Example 16 wherein the vessel is cylindrical and the opening has a circular cross-sectional shape.

In Example 22, the method of Example 16 wherein the vessel is a drinking vessel for human use.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. The drawings may not be to scale. Further features and advantages will become apparent from the following, more detailed, description of the various aspects, embodiments, and configurations of the disclosure, as illustrated by the drawings referenced below.

FIG. 1 is a schematic cross-sectional view illustrating an exemplary glass bottom vessel.

FIG. 2 is a schematic top view illustrating the exemplary glass bottom vessel of FIG. 1.

FIG. 3 is a schematic cross-sectional, exploded view illustrating the exemplary glass bottom vessel of FIG. 1 prior to glass fusing.

FIG. 4 is a flow diagram of an exemplary process to form a glass bottom vessel.

FIG. 5 is a schematic cross-sectional view illustrating an alternative exemplary glass bottom vessel.

FIG. 6 is a schematic top view illustrating the glass bottom vessel of FIG. 5.

FIG. 7 is a schematic cross-sectional view illustrating an alternative exemplary glass bottom vessel.

FIG. 8 is a schematic top view illustrating the exemplary glass bottom vessel of FIG. 7.

FIG. 9 is a schematic cross-sectional, exploded view illustrating the exemplary glass bottom vessel of FIG. 7 prior to glass fusing.

FIG. 10 is a schematic cross-sectional view illustrating a still further alternative exemplary glass bottom vessel.

### DETAILED DESCRIPTION

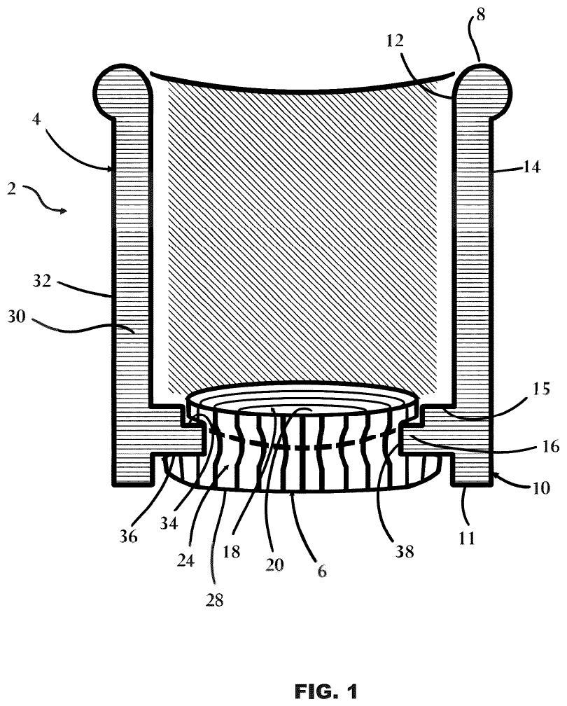

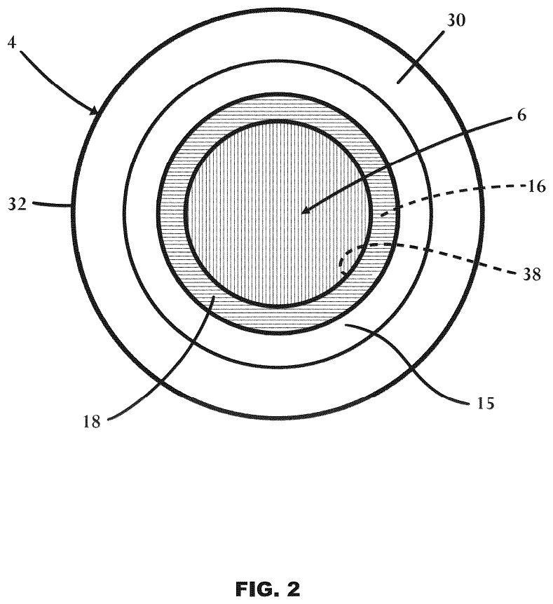

The present disclosure provides a new, visually appealing vessel with a glass portion, such as a glass bottom. The glass bottom can form part of a leak-proof or water tight bottom. In some embodiments, the vessel is capable of holding food and/or liquid without leaking. FIG. 1 is a schematic cross-sectional view and FIG. 2 is a top view of glass bottom vessel 2, which has ceramic body 4 and glass bottom 6. Glass bottom 6 is connected to and forms a sealed bottom on ceramic body 4 such that glass bottom vessel 2 can hold food and/or liquid without leaking. In one embodiment, glass bottom vessel 2 is a drinking vessel, such as a mug which can hold a beverage for consumption by the user.

Ceramic body 4 includes lip 8, recessed foot 10 (having bottom edge 11), wall 30 (having inner surface 12, outer surface 14), and interior floor 15 (having support shelf 16.) Ceramic body 4 is formed from ceramic, which is clay hardened by heat. In some embodiments, ceramic body 4 can be cylindrical or substantially cylindrical. In other embodiments, ceramic body 4 can have any cross-sectional shape and glass bottom 6 can have substantially the same cross-sectional shape or can have different cross-sectional shapes. Lip 8 is located at the top of ceramic body 4 and is opposite recessed foot 10. Wall 30 extends between lip 8 and bottom edge 11 of recessed foot 10 and forms an enclosed space. As shown in FIG. 1, this enclosed space can be generally cylindrical or tubular. When ceramic body 4 is a mug as illustrated in FIG. 1, lip 8 is the mouth or drinking surface. Bottom edge 11 of recessed foot 10 is a flat surface for resting the ceramic body 4 on a surface, such as a table.

A glaze may be on all or substantially all surfaces of ceramic body 4. For example, in some embodiments, the glaze may be present on all surfaces except bottom edge 11. For example, the glaze may be present on outer surface 14, inner surface 12, interior floor 15, and inner surface 34 and outer surface 36 of support shelf 16. In some embodiments, the glaze is not present on vertical surface 38 so that the glaze is not positioned between first disk 18 and second disk 24. In some embodiments, glaze 32 may be formed from one or more separate or different glazes. For example, a first glaze may be used on outer surface 14 and a second (different) glaze may be used on inner surface 12.

Ceramic body 4 is formed with a hole or opening in the bottom (interior floor 15). As such, ceramic body 4 cannot hold liquid and is not a leakproof vessel. However, glass bottom 6 together with ceramic body 4 may form a leakproof vessel. As shown in FIG. 1, the opening in the bottom of ceramic body 4 is defined by vertical surface 38 of support shelf 16 (i.e., the inner diameter of support shelf 16 and floor 15.)

The floor of ceramic body 4 has a stepped configuration, with floor 15 being vertically upward or above support shelf 16 and support shelf 16 extending radially inward from the vertical edge of floor 15. Support shelf 16 extends radially inward or towards the center of ceramic body 4 from inner surface 12. It is located vertically downward from lip 8 and vertically upward from recessed foot 10. Support shelf 16 can have inner surface 34, outer surface 36 and vertical surface 38. Vertical surface 38 of support shelf 16 defines the opening in the bottom of ceramic body 4. Glaze 32 can be present on inner surface 34, outer surface 36 and vertical surface 38 of support shelf 16. In some embodiments, glaze 32 may only be present on inner surface 34 and outer surface 36 such that glass from glaze 32 is not introduced between first disk 18 and second disk 24.

In FIG. 1 and FIG. 2, support shelf 16 is a single, continuous support that extends the entire perimeter of inner surface 12. In other embodiments, support shelf 16 may include gaps such that shelf does not extend continuously about the entire perimeter of the inner surface. In this way, support shelf 16 may be formed of two or more portions.

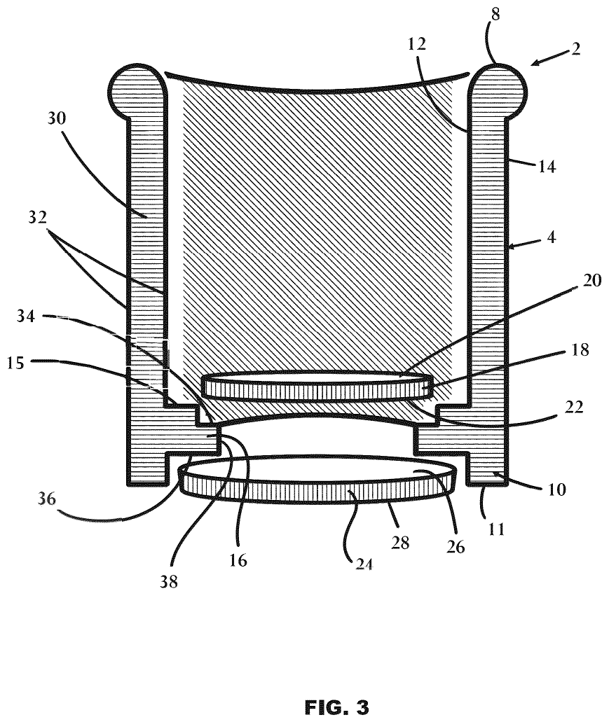

Glass bottom 6 includes first or inner disk or portion 18, which has top or inner surface 20 and bottom surface 22 (shown in FIG. 3) and second or outer disk or portion 24, which has top surface 26 (shown in FIG. 3) and bottom surface 28. First disk 18 is positioned on top of second disk 24. Inner surface 20 of first disk 18 forms the bottom inside surface of glass bottom vessel 2, and bottom surface 28 of second disk 24 forms a portion of the bottom outside surface of glass bottom vessel 2. Top surface 20 and interior floor 15 can form a flat or substantially flat bottom surface inside glass bottom vessel 2. As used herein, the term substantially means within 0.5%, 1.0%, 2.0% or 5.0%. For example, substantially flat can describe a surface or object that is mostly, but not necessarily perfectly, level or even. It implies that the surface is generally flat with only minor deviations or irregularities that do not significantly affect its overall flatness. In some embodiments, the levelness of the surface may deviate by not more than 0.5%, 1.0%, 2.0% or 5.0%

First disk 18 and second disk 24 are formed from glass. Suitable glass includes various types of cold glass, such as artisanal glass. In one example, first disk 18 and second disk 24 are formed from glass having a COE of about 96. The glass of first disk 18 and second disk 24 can be transparent, semi-transparent or opaque. First disk 18 and second disk 24 can be level or flat. First disk 18 and second disk 24 can have a consistent thickness across the width or diameter of the disk. In some embodiments, the first disk 18 and second disk 24 have the same thickness. In other embodiments, first disk 18 and second disk 24 have different thicknesses.

First disk 18 and second disk 24 can be formed by any known method of making glass disks or objects. The glass of first disk 18 and second disk 24 do not need to be identical so long as the coefficient of expansion factor (COE) is the same or substantially the same and the glass is compatible with each other. COE refers to the rate at which the glass expands or contracts with changes in temperature. Mixing different standardized COE types may lead to first disk 18 and second disk 24 being incompatible. In some embodiments, first disk 18 and second disk 24 are formed from the same glass. In other embodiments, first disk 18 and second disk 24 are formed from different glass materials which have substantially similar COEs, as recognized by one of skill in the art.

First disk 18 and second disk 24 sandwich support shelf 16. As explained herein, first disk 18 and second disk 24 are fused to one another. In some embodiments, first disk 18 and second disk 24 can also fuse to the glaze on support shelf 16. Together glass bottom 6 (first disk 18 and second disk 24) and ceramic body 4 can form a leakproof (or water tight) vessel 2 capable of holding food and/or liquid for example for human consumption.

The portion of wall 30 which extends between bottom edge 11 and outer surface 36 may be referred to as recessed foot 10. In some embodiments, recessed foot 10 can be sized such that bottom surface 28 of second disk 24 does not touch a flat surface, such as a table surface, when glass bottom vessel 2 is placed on the flat surface. That is, bottom surface 28 may be located along a vertical plane that is vertically upward of the vertical plane of bottom edge 11. In other embodiments, bottom surface 28 is level with bottom edge 11 such that the bottom surface 28 touches a table surface when glass bottom vessel 2 is placed on a table or other flat surface (i.e., bottom surface 28 and bottom edge 11 are in the same vertical plane).

In some embodiments, a sealant can be used between glass bottom 6 and ceramic body 4. In some embodiments, the sealant further adds to the leak-proof seal formed between glass bottom 6 and ceramic body 4. In some embodiments, the sealant can be positions around the outer edge(s) of glass bottom 6 and contacts glass bottom 6 and ceramic body 4. For example, a sealant can be present along the outer edge of second disk 24 and in contact with, for example, outer surface 36 of support shelf 16. In other embodiments, a sealant can be present on the inner surface of glass bottom vessel 2, for example, along the outer edge of first disk 18 and in contact with interior floor 15 and/or support shelf 16. When glass bottom vessel 2 is intended to hold items for human consumption, such as food or beverage, the sealant should be food safe. The sealant should be capable of bonding to ceramic and glass and forming a water tight or waterproof seal. In some embodiments, the sealant is dishwasher safe, microwavable safe and/or food safe. Suitable sealants include Sil-Bond (RTV 4500), a one component room temperature vulcanizing RTV acetoxy cure silicone sealant and adhesive available from Silco Incorporated, Mentor, OH, USA and gold leaf.

FIG. 3 is a schematic cross-sectional, exploded view of glass bottom vessel 2. As explained herein, during assembly, first disk 18 and second disk 24 are fused to form glass bottom 6. In FIG. 1, a dashed line represents the imaginary boundary between fused first disk 18 and second disk 24. FIG. 3 illustrates glass bottom vessel 2 prior to the fusion. As shown, first disk 18 is positioned inside ceramic body 4 and on top of inner surface 34 of support shelf 16. Second disk 24 is positioned on the outside of ceramic body 4 and below first disk 18.

n some embodiments, first disk 18 has a cross sectional area and diameter smaller than that of second disk 24. First disk 18 can be sized such that it fits within the notch formed by support shelf 16 and interior floor 15 in the radial direction, vertical direction or both the radial and vertical directions. For example, first disk 18 may have a diameter smaller than the interior diameter of interior floor 15 and larger than support shelf 16. In this way, when first disk 18 is placed within ceramic body 4 and centered on the opening formed by support shelf 16, it sits on inner surface 34 of support shelf 16. First disk 18 can also be sized such that it fits within the notch formed by support shelf 16 and interior floor 15. Still further, the thickness of first disk 18 can be sized such that inner surface 20 of first disk 18 and interior floor 15 form a substantially flat, level surface.

Second disk 24 is positioned below first disk 18 and on the opposite side of support shelf 16. In some embodiments, second disk 24 has a diameter smaller than the inner diameter of ceramic body 4 (inner diameter formed by recessed foot 10) and larger than the diameter of first disk 18. When second disk 24 is centered on the opening formed by support shelf 16, second disk 24 is larger than the opening formed by support shelf 16 and a portion of top surface 26 is adjacent to or is in contact with outer surface 36. In other embodiments, second disk 24 and first disk 18 can have the same diameter.

The glass of first disk 18 and second disk 24 can be transparent, semi-transparent or opaque. Using glass that is transparent or semi-transparent allows the user of glass bottom vessel 2 to see through the bottom of the vessel, adding visual appeal. For example, when glass bottom vessel 2 is a mug, the user can see through the bottom of the mug when drinking from it. In some embodiments, designs can be created in glass bottom 6 by inserting suitable materials, such as frit or a metallic overglaze or lustre between first disk 18 and second disk 24, before the first disk 18 and the second disk 24 are fused to one another. In some embodiments, the metallic overglaze or lustre is a low-fire (cone 18) metallic overglaze or lustre.

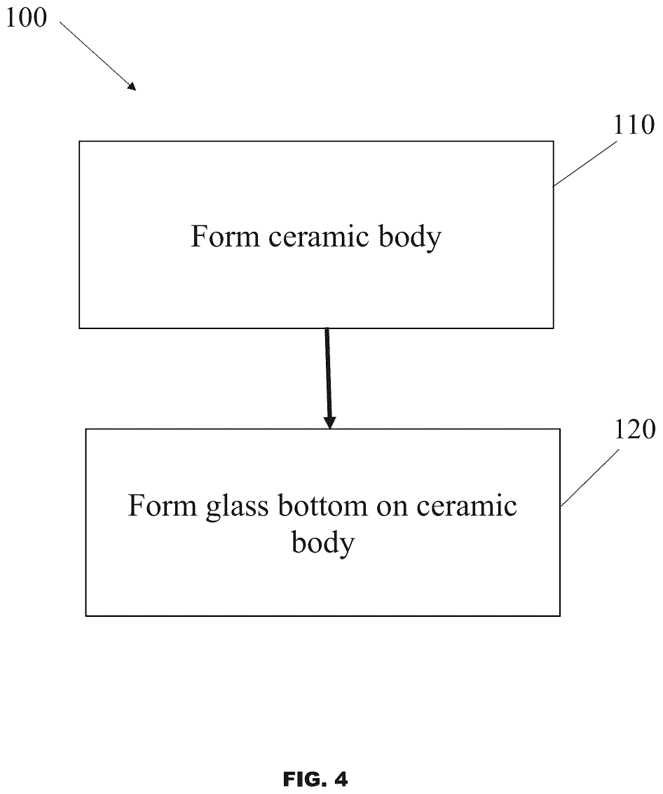

FIG. 4 is a flowchart showing method 100 of making glass bottom vessel 2, which includes forming a ceramic body in step 110 and forming a glass bottom on the ceramic body in step 120. In step 110, ceramic body 4 may be formed by forming clay into a desired shape, firing the clay to harden, applying glaze to the fired clay and then firing the piece a second time. There are three main types of clay: earthenware clay, stoneware clay, and porcelain. Each clay can be used to make ceramic. However, the firing temperatures and physical properties of the ceramic can vary. Two firing are completed to form the ceramic body in step 110. The first firing, referred to as the bisque fire, transforms the clay into ceramic. During the bisque firing, glass is formed in the clay and this glass fills the pores between the clay particles. The bisque firing temperature is determined based on the type of clay used. While the bisque firing forms glass within clay body, this is not sufficient to create a watertight surface. Thus, a glaze is further required to create a watertight surface on the ceramic body. After applying a glaze, the vessel is fired a second time. The second firing can be referred to as the glaze firing. A glaze typically contains four types of components: silica, alumina, flux, and colorant. The silica is a glass-forming ingredient. During the glaze firing, the silica in the glaze melts and forms a glass-like surface on the piece. The alumina affects the viscosity of the glaze, and the flux controls the melting point of the glaze. Similar to the bisque firing temperature, the glaze firing temperature varies depending on the type of glaze and the type of clay used.

As described herein, the ceramic vessel or body is created with a through-hole. For example, a hole is formed in the bottom of the ceramic body. In step 120, a glass bottom is formed on the ceramic body 4 to create the glass bottom vessel and to close or fill the hole in the ceramic body. In some embodiments, first disk 18 is positioned inside ceramic body 4 such that it is in contact with inner surface 34 of support shelf 16 and completely covers the opening in the bottom of ceramic body 4. Second disk 24 is positioned from the opposite side of support shelf 16 such that it is in contact with outer surface 36 of support shelf 16. This forms a sandwich structure in which support shelf 16 is positioned between first disk 18 and second disk 24. In some embodiments, designs can be created by inserting suitable materials, such as frit or a metallic overglaze or lustre between first disk 18 and second disk 24 as this stage.

The assembly (i.e., ceramic body 4, first disk 18 and second disk 24) is placed in a kiln and fired at a low temperature. This third firing, or fusing firing, is conducted at a sufficient temperature and for a sufficient length to fuse first disk 18 to second disk 24. In some embodiments, a suitable temperature for the third firing is about 1200-1300° F. The glaze or glazes on ceramic body 4 should be compatible with the temperatures necessary to fuse first disk 18 and second disk 24. For example, the fusing temperature of the first disk 18 and the second disk 24 is low enough such that the first disk 18 and second disk 24 slump, and the melting point of the glaze is sufficiently high enough such that the third firing does not reactivate the glaze. In some embodiments, the bisque temperature (the temperature required to transform the clay into ceramic) is higher than the glaze firing temperature (the temperature required to melt the silica in the glaze) and the glaze firing temperature is higher than the fusing firing temperature (the temperature required to slump the glass of the glass bottom).

After the third firing, glass bottom vessel 2 is allowed to cool to room temperature and then removed from the kiln. One skilled in the art will recognize that certain types of glass may need to be cooled at different rates to avoid the piece cracking.

The first disk 18 may sink as it fuses with second disk 24. This sinking may be more prominent in the middle than at the edges of first disk 18. This may create glass bottom 6 in which the edges of first disk 18 are flush or substantially flush with interior floor 15 and then dips or sinks towards the radial center of first disk 18 such that a depression is formed at the center of first disk 18.

The third firing can create a watertight bottom on glass bottom vessel 2 because first disk 18 and second disk 24 fuse together. It is also believed that first disk 18 and second disk 24 fuse to the glaze on support shelf 16, which increases the quality or strength of the bond. In some embodiments, bottom surface 28 of second disk 24 can be flush with bottom edge 11 before the third firing. In these embodiments, second disk 24 can sit on a kiln shelf and a separator, such as kiln paper, can be used between second disk 24 and the kiln shelf during the third firing. In other embodiments, bottom surface 28 of second disk 24 is recessed such that it is vertically above bottom edge 11 before and after the third firing. In these embodiments, second disk 24 can be elevated from the kiln shelf, for example, with a stack of kiln paper during the third firing.

The thickness of first disk 18 and second disk 24 may change during the firing. In some embodiments, the thickness of second disk 24 is selected so that prior to firing, the thickness of second disk 24 is less than the height of recessed foot 10. This creates a recessed glass bottom on glass bottom vessel 2.

In some embodiments, after the vessel 2 has cooled to room temperature, a sealant may be applied to create or enhance a watertight seal. For example, a sealant can be applied to the underside of vessel 2 between ceramic body 4 and glass bottom 6.

Ceramics and glass typically have different expansion rates and melting points, making them generally incompatible. The method disclosed herein forms a vessel by fusing glass disks to each other and, in some embodiments, to the glaze on the ceramic vessel. By fusing the glass disks after the second firing (e.g., the glaze firing), a lower firing temperature may be used for fusing the glass. In comparison, if glass was incorporated into the structure during or before the first or second firings, the glass would be exposed to higher temperatures, which may damage the glass. The lower temperature of the third firing is compatible with glass fusing. Additionally, in some embodiments, the temperature of the third firing does not impact the quality of the glaze. Further, the glass disks sandwich a portion of the clay body, providing further support for the bottom and connection between the glass disks and the clay body.

The resulting glass bottom vessel 2 can be leakproof or water tight. In some embodiments, water tight means when the vessel contains liquid, such liquid cannot escape, for example by leaking or seeping, through the vessel. For example, when the vessel is an open-top vessel, such as a mug, liquid may evaporate and leave the vessel through the open top but does not otherwise leave the vessel, such as by seeping or leaking through the walls or bottom of the vessel. In some embodiments, glass bottom vessel 2 is leakproof for at least 30 minutes, 1 hour, 2 hours, 3 hours, 4 hours, 5 hours or at least 10 hours. In some embodiments, glass bottom vessel 2 is leakproof for at least 1 day (24 hours). One way to determine if glass bottom vessel 2 is leakproof is to set glass bottom vessel 2 on a dry towel and check the towel for moisture (leaked liquid) periodically.

The resulting glass bottom vessel 2 may be food safe if appropriate materials and temperatures are used. That is, the glass does not make a previously food safe vessel not food safe if the glass used is food safe and the temperature of each of the three firings firing is appropriate for the materials present in glass bottom vessel 2.

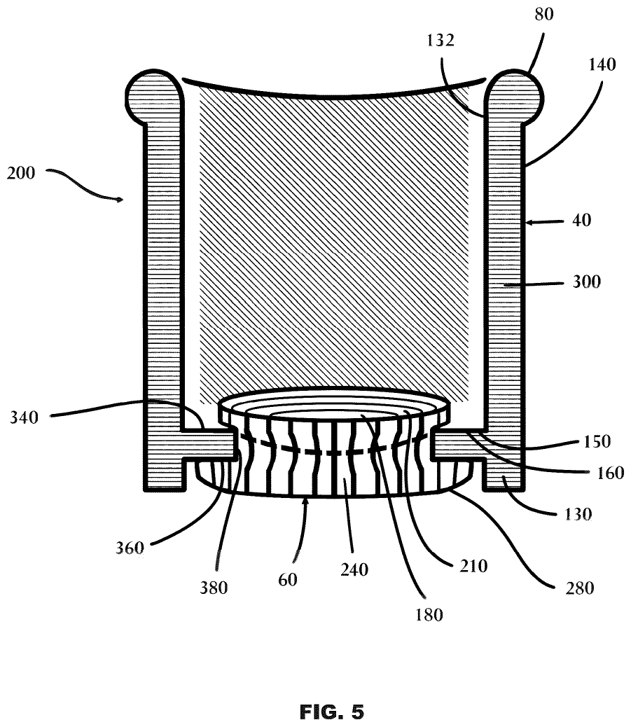

FIG. 5 is an alternative embodiment showing vessel 200 having ceramic body 40 and glass bottom 60. Ceramic body 40 has wall 300 which extends from lip 80 to recessed foot 130. Wall 30 includes inner surface 132 and outer surface 140. Wall 300 can have a circular cross-sectional shape such that ceramic body 40 generally has a cylindrical shape. Interior floor 150 and support shelf 160 extend radially inward from inner surface 132 of wall 300. Interior floor 150 and support shelf 160 are the same height. That is, a notch or step is not formed between interior floor 150 and support shelf 160, and vertical surface 380 extends from inner surface 340 of interior floor 150 and support shelf 160 to exterior surface 360 of interior floor 150 and support shelf 160.

First disk 180 and second disk 240 are fused together to form glass bottom 60. Top surface 210 of first disk 180 is exposed on the inside of ceramic body 40 and bottom surface 280 of second disk 240 is exposed on the outside of ceramic body 40. First disk 180 and second disk 240 sandwich interior floor 150. In some embodiments, the diameter of first disk 180 and second disk 240 are the same. In other embodiments, the diameter of first disk 180 and second disk 240 are different. In some embodiments, first disk 180 and second disk 240 have diameters larger than the hole in the bottom of the vessel formed by vertical surface 380.

Although certain pieces, such as ceramic body 4 (and 40), first disk 18 (and 180) and second disk 24 (and 240) are discussed herein as having a circular or substantially circular cross-sectional shape, one skilled in the art will recognize that the pieces may have any suitable shape so long as the same sizing principles are applied as described herein with respect to diameters and/or widths. For example, the opening in the ceramic body 4, first disk 18 and second disk 24 can have a triangular cross-sectional shape. Further, the cross-sectional shapes of ceramic body 4, first disk 18 and second disk 24 can be the same or different as illustrated herein.

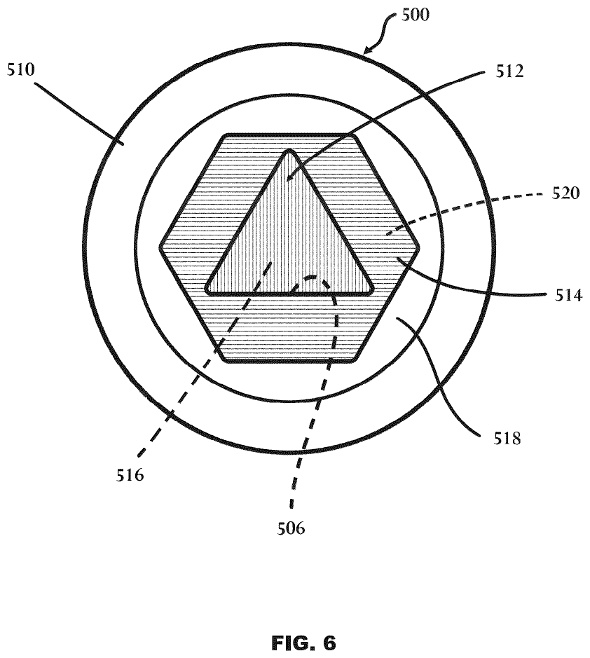

FIG. 6 is a schematic top view of glass bottom vessel 500 which has ceramic body 510 and glass bottom 512. FIG. 6 illustrates a vessel having a non-circular hole in the bottom and a non-circular first glass disk. Glass bottom 512 is connected to and forms a sealed bottom on ceramic body 510 such that glass bottom vessel 500 can hold food and/or liquid without leaking. Glass bottom vessel 500 is similar to glass bottom vessel 2 or glass bottom vessel 200. Glass bottom 512 is formed from first disk 514 fused to second disk 516. One difference of glass bottom vessel 500 is that first disk 514 does not have a circular cross-sectional shape. First disk 514 in FIG. 6 has a hexagonal cross-sectional shape. Second disk 516 can have a matching cross-sectional shape (i.e., hexagonal) or a different cross-sectional shape (i.e., circular). First disk 514 and second disk 516 should be shaped and sized such there are no gaps between glass bottom 512 and ceramic body 510.

Another difference is that the opening formed in interior floor 518 of ceramic body 510 is not circular. In FIG. 6, the opening formed by vertical surface 506 of support shelf 520 has a triangular cross-sectional shape. In use, this results in a non-circular design in interior floor 518 of glass bottom vessel 500. In other embodiments, the vessel may have a circular hole in the bottom and a non-circular first glass disk or the vessel may have a non-circular hole in the bottom and a circular first glass disk.

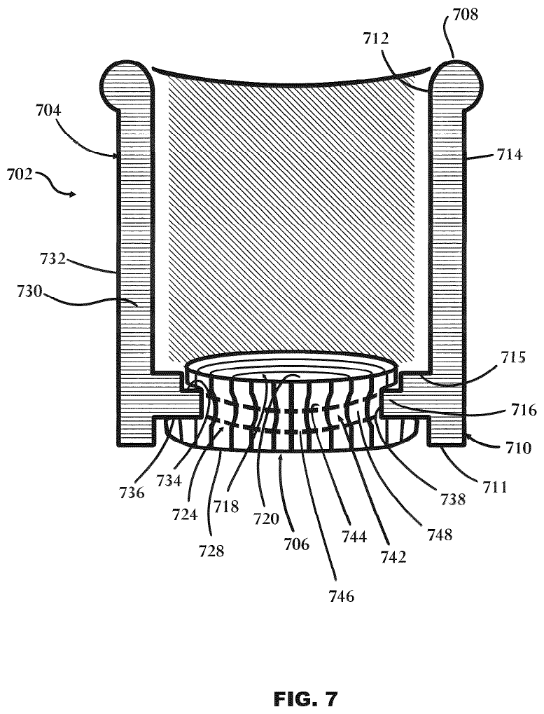

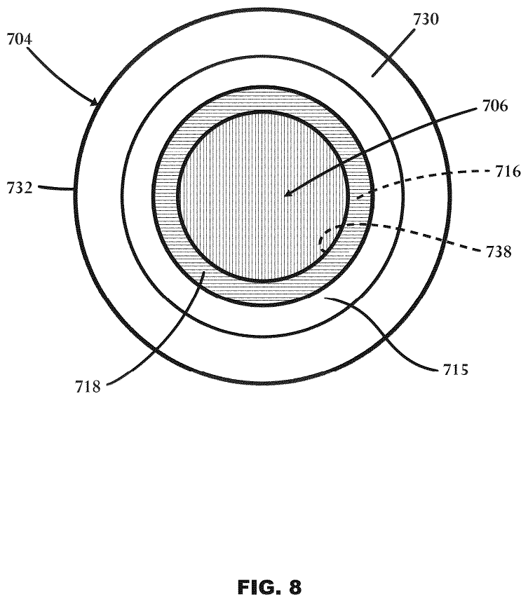

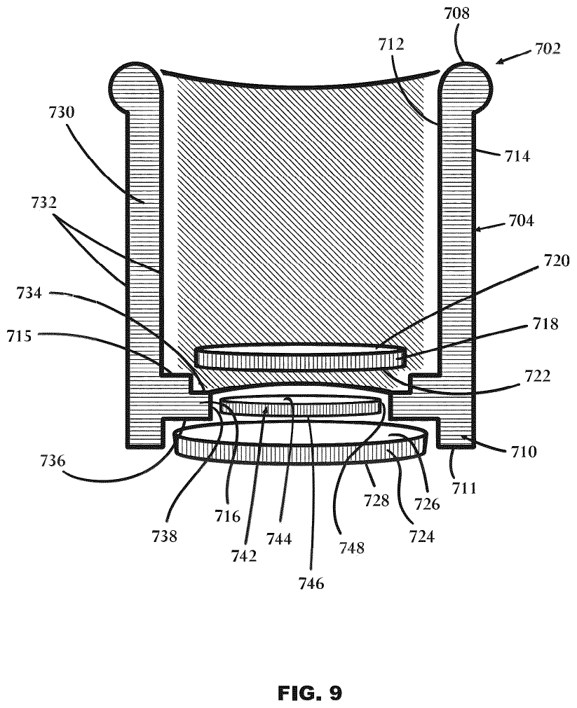

FIG. 7 is an alternative embodiment showing vessel 702 having ceramic body 704 and glass bottom 706. FIG. 8 is a top-view of vessel 702 and FIG. 9 is a cross-sectional, exploded view of vessel 702 prior to fusing the glass bottom 706. Ceramic body 704 has wall 730 which extends from lip 708 to recessed foot 710, which includes bottom edge 711. Wall 730 includes inner surface 712 and outer surface 714. Glaze 732 can be applied to wall 730. Wall 730 can have a circular cross-sectional shape such that ceramic body 704 generally has a cylindrical shape. Interior floor 715 and support shelf 716 extend radially inward from inner surface 712 of wall 730. Similar to FIG. 1, a notch is formed by interior floor 715 and support shelf 716. Support shelf includes inner surface 734, outer surface 736 and vertical wall 738.

Glass bottom 706 is formed from three separate glass disks or portions, first disk 718, second disk 724 and third disk 742. First disk 718 has top surface 720 and bottom surface 722. Second disk 724 has top surface 726 and bottom surface 728. Third disk 742 has top surface 744, bottom surface 746 and outer edge 748. In some embodiments, first disk 718 is immediately adjacent to third disk 742 which is immediately adjacent to second disk 724. For example, bottom surface 722 may be immediately adjacent to or in contact with top surface 744, and bottom surface 746 may be immediately adjacent to or in contact with top surface 726. In some embodiments, outer edge 748 of third disk 742 can contact vertical wall 738.

First disk 718, second disk 724 and third disk 742 are fused together to form glass bottom 706. Top surface 720 of first disk 718 is exposed on the inside of ceramic body 704 and bottom surface 728 of second disk 724 is exposed on the outside of ceramic body 704. First disk 718, second disk 724 and third disk 742 sandwich interior floor 715. In some embodiments, first disk 718 is similar to first disk 18 in FIG. 1 and second disk 724 is similar to second disk 24 in FIG. 1. In some embodiments, the diameter of first disk 718, second disk 724 and third disk 742 are different. For example, the diameter of first disk 718 and second disk 724 can be larger than the diameter of third disk 742. In some embodiments, the diameter of third disk 742 may be smaller than the diameter of the opening in the bottom of ceramic body 704 (the opening defined by vertical wall 738). In some embodiments, the diameter of first disk 718 and second disk 724 are larger than the opening in the bottom of ceramic body 704 and the diameter of third disk 742 is smaller than the opening such that third disk 742 fits within the opening, first disk 718 is on top of the opening and second disk 724 is below the opening.

In some embodiments, first disk 718, second disk 724 and third disk 742 can have the same thickness. In other embodiments, glass disks 718, 724 and 742 can have different thicknesses. In some embodiments, third glass disk 742 can have a thickness less than the thickness of vertical wall 738, and first and second disks 718 and 724 can have a thickness greater than third disk 742.

Glass disks 718, 724 and 742 can be slumped as described herein to fuse the glass disks together. During the slumping or fusing process, the glass of glass disks 718, 724 and 742 can fill in the gaps between the glass disks and ceramic body 704 to create a leakproof seal.

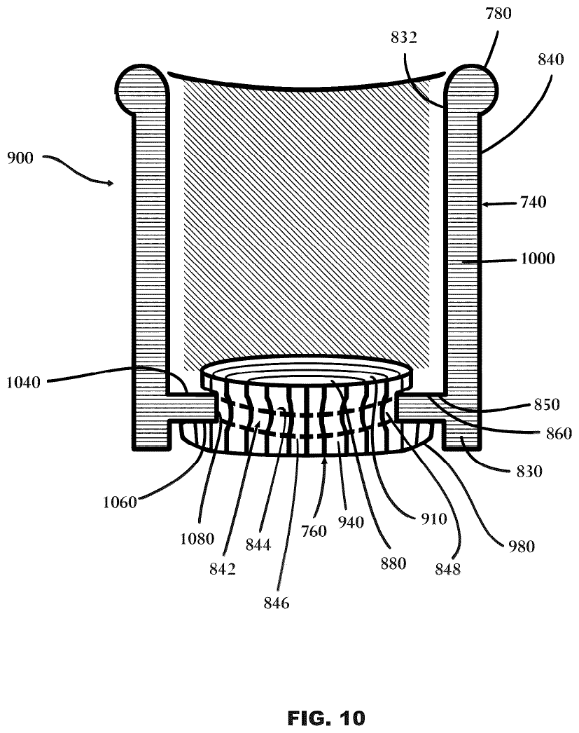

FIG. 10 is an alternative embodiment showing vessel 900 having ceramic body 740 and glass bottom 760. Ceramic body 740 has wall 1000 which extends from lip 780 to recessed foot 830. Wall 1000 includes inner surface 832 and outer surface 840. Wall 1000 can have a circular cross-sectional shape such that ceramic body 740 generally has a cylindrical shape. Similar to vessel 200 of FIG. 5, interior floor 850 and support shelf 860 extend radially inward from inner surface 832 of wall 1000. Interior floor 850 and support shelf 860 are the same height. That is, a notch or step is not formed between interior floor 850 and support shelf 860, and vertical surface 1080 extends from inner surface 1040 of interior floor 850 and support shelf 860 to exterior surface 1060 of interior floor 850 and support shelf 860.

Glass bottom 760 is formed from three glass disks or portions, first disk 880 (having top surface 910 and a bottom surface), second disk 940 (having a top surface and bottom surface 980), and third disk 842 (having top surface 844, bottom surface 846 and outer or parameter surface 848). First disk 880, second disk 940 and third disk 842 are fused together to form glass bottom 760. Top surface 910 of first disk 880 is exposed on the inside of ceramic body 740 and bottom surface 980 of second disk 940 is exposed on the outside of ceramic body 740. Similar to vessel 702 of FIG. 7, First disk 880, second disk 940 and third disk 842 sandwich interior floor 850. In some embodiments, the diameters of first disk 880, second disk 940 and third disk 842 are different. In some embodiments, first disk 800 and second disk 940 can have diameters larger than the diameter of third disk 842. For example, in some embodiments, first disk 880 and second disk 940 have diameters larger than the hole in the bottom of the vessel formed by vertical surface 1080 and third disk 842 has a diameter smaller than the hole such that third disk 842 can fit within the hole. In this way, first disk 800 and second disk 940 fuse or otherwise attach to ceramic body 740.

Although the forgoing disclosure discusses a glass bottom mug, one skilled in the art will recognize that the glass bottom vessel may be any suitable vessel such as a vase, coaster, plate, bowl or cup.

Although the forgoing disclosure discusses a glass bottom made with two or three glass portions or disks, a glass bottom can be formed using more than three glass portions or disks, for example by using four, five or six glass portions or disks.

Although the forgoing disclosure described the glass portions as a bottom, the glass portions can be used at other locations on the ceramic body.

In the foregoing, all temperatures are set forth uncorrected in degrees Fahrenheit and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A vessel comprising:
a ceramic body having a top edge, a bottom edge, a wall extending from the top edge to the bottom edge to form an enclosed space and a floor extending inward from an inside surface of the wall, the floor having an inner surface, an outer surface and a vertical surface that defined an opening in the ceramic body; and
a glass bottom covering the opening, the glass bottom formed of a first glass portion and a second glass portion which are fused together, wherein the first glass portion has a first top surface and a first bottom surface and the second glass portion has a second top surface and a second bottom surface; the first bottom surface of the first glass portion is in contact with at least a portion of the inner surface of the floor and at least a portion of the second top surface of the second glass portion; the second top surface of the second glass portion is in contact with at least a portion of the first bottom surface of the first glass portion and at least a portion of the outer surface of the floor.

2. The vessel of claim 1 wherein at least a portion of the inner surface of the floor which is in contact with the first glass portion and at least a portion of the outer surface of the floor which is in contact with the second glass portion include at least one glaze.

3. The vessel of claim 1 wherein the vessel is watertight.

4. The vessel of claim 1 wherein the ceramic body is cylindrical.

5. The vessel of claim 4 wherein the opening is circular.

6. The vessel of claim 5 wherein the floor includes one or more supports and the first glass portion and the second glass portion are in contact with the one or more supports.

7. The vessel of claim 6 wherein a first diameter of the first glass portion is larger than a diameter of the opening, and wherein a second diameter of the second glass portion is larger than the first diameter of the first glass portion.

8. The vessel of claim 6 wherein the support forms a notch.

9. The vessel of claim 6 wherein the vessel includes two or more supports extend radially inward from the floor towards the opening and wherein the supports do not extend an entire perimeter of the opening.

10. The vessel of claim 1 wherein the second bottom surface of the second portion is laterally upwards from the bottom edge.

11. The vessel of claim 1 wherein the inner surface of the floor and the first top surface of the first glass portion form a flat or substantially flat surface.

12. The vessel of claim 1 wherein the vessel is a drinking vessel.

13. The vessel of claim 1 wherein the glass bottom further comprises a third glass portion positioned between the first glass portion and the second glass portion, the first glass portion, the second glass portion and the third glass portion fused together.

14. The vessel of claim 1 and further comprising a sealant contacting the ceramic body and the glass bottom.

15. A method of forming a glass bottom vessel, the method comprising:
positioning a first glass portion in contact with at least a portion of an inner surface of a floor extending inward from an inside surface of a wall of a ceramic body and over an opening formed in the floor of the ceramic body;
positioning a second glass portion in contact with at least a portion of an outer surface of the floor and in contact with the first glass portion; and
fusing the first glass portion to the second glass portion to sandwich the floor between the first glass portion and the second glass portion.

16. The method of claim 15 wherein the step of positioning the first glass portion includes position the first glass portion in a notch.

17. The method of claim 15 wherein the step of positioning the second glass portion includes elevating the second glass portion so that an outer surface of the second glass portion is laterally upwards from a bottom edge of the ceramic body.

18. The method of claim 15 wherein the ceramic body has been glaze fired before the step of positioning the first glass portion.

19. The method of claim 15 wherein the outer surface and the inner surface have a glaze.

20. The method of claim 15 wherein the ceramic body is cylindrical and the opening has a circular cross-sectional shape.
